(19) United States
(12) Patent Application Publication
(10) Pub. No.: US 2022/0050562 A1
(43) Pub. Date: Feb. 17, 2022

(54) METHODS AND APPARATUSES FOR GENERATING A HOSTED APPLICATION

(71) Applicant: Shanghai Lianshang Network Technology Co., Ltd., Shanghai (CN)

(72) Inventor: Yong SU, Shanghai (CN)

(21) Appl. No.: 17/452,686

(22) Filed: Oct. 28, 2021

Related U.S. Application Data
(63) Continuation of application No. PCT/CN2020/086040, filed on Apr. 22, 2020.

(30) Foreign Application Priority Data
Apr. 28, 2019 (CN) 201910350642.7

(51) Int. Cl. G06F 3/0483; G06F 3/0482

(52) U.S. Cl. CPC G06F 3/0483; G06F 2203/04803; G06F 3/0482

(57) ABSTRACT

Embodiments of the present application disclose a method and an apparatus for generating a hosted application. A specific embodiment of the method comprises: displaying a page containing identifiers of at least two hosted applications in response to detecting a user preset operation; in response to detecting a selection operation on at least two identifiers of the identifiers of the at least two hosted applications, determining at least two selected hosted applications indicated by the at least two identifiers; and generating a combined hosted application based on the at least two selected hosted applications, wherein the combined hosted application is used to display a page of at least any one of the at least two selected hosted applications.

### CROSS REFERENCE TO THE RELATED APPLICATION

This application is a continuation of International Application No. PCT/CN2020/086040, filed on Apr. 22, 2020, which claims the benefit of priority to Chinese Patent Application No. 201910350642.7, filed on Apr. 28, 2019, the benefit of priority of each of which is claimed herein and which applications are hereby incorporated by reference herein in their entirety.

### TECHNICAL FIELD

Embodiments of the present application relate to computer technology, specifically relate to internet technology, and more specifically relate to methods and apparatuses for generating a hosted application.

### BACKGROUND

Generally, a page of a hosted application is displayed in full screen on a variety of terminal devices such as mobile phones. Thus, when a page of a hosted application is displayed on a display, the user is required to close the display of the hosted application being currently viewed in the foreground and initiate display of another hosted application in the foreground to view the page of the other hosted application.

The user is required to exit and enter two or more hosted applications back and forth if the user desires to view these hosted applications for a period of time, resulting in a relatively complicated operation process.

### SUMMARY

Embodiments of the present application present methods and apparatuses for generating a hosted application.

In a first aspect, an embodiment of the present application provides a method, implemented at a terminal device, for generating a hosted application. The terminal device is installed with an application in which at least two hosted applications are integrated. The method comprises: in response to detecting a user preset operation, displaying a page containing identifiers of the at least two hosted applications; in response to detecting a selection operation on at least two identifiers of the identifiers of the at least two hosted applications, determining at least two selected hosted applications indicated by the at least two identifiers; and generating a combined hosted application based on the at least two selected hosted applications, wherein the combined hosted application is used to display a page of at least any one of the at least two selected hosted applications.

In a second aspect, an embodiment of the present application provides an apparatus for generating a hosted application. The apparatus comprises: a display unit configured to display, in response to detecting a user preset operation, a page containing identifiers of at least two hosted applications; a determination unit configured to determine, in response to detecting a selection operation on at least two identifiers of the identifiers of the at least two hosted applications, at least two selected hosted applications indicated by the at least two identifiers; and a generation unit configured to generate a combined hosted application based on the at least two selected hosted applications, wherein the combined hosted application is used to display a page of at least any one of the at least two selected hosted applications.

In a third aspect, an embodiment of the present application provides an electronic device. The electronic device comprises: one or more processors; a storage device for storing one or more programs, the one or more programs, when executed by the one or more processors, causing the one or more processors to implement the method as recited in any embodiment of the methods for generating a hosted application.

In a fourth aspect, an embodiment of the present application provides a computer readable storage medium having computer programs stored thereon, the computer programs, when executed by a processor, implementing the method as recited in any embodiment of the methods for generating a hosted application.

A solution for generating a hosted application provided in the embodiments of the present application first displays a page containing identifiers of at least two hosted applications in response to detecting a user preset operation; then determines, in response to detecting a selection operation on at least two identifiers of the identifiers of the at least two hosted applications, at least two selected hosted applications indicated by the at least two identifiers; and finally generates a combined hosted application based on the at least two selected hosted applications, wherein the combined hosted application is used to display a page of at least any one of the at least two selected hosted applications. The solution provided in the embodiments of present application enables operations on multiple selected hosted applications in the combined hosted application, which prevents the user from switching between the multiple hosted applications in the foreground to operate on the multiple hosted applications and provides convenience and efficiency to user operations.

### DESCRIPTIONS OF THE DRAWINGS

Other features, objects, and advantages of the present application will become more apparent by reading the detailed description of non-limiting embodiments with reference to the following drawings:

FIG. 1 is an exemplary system architecture diagram in which the present application can be applied;

FIG. 2a is a flowchart of an embodiment of a method for generating a hosted application according to the present application;

FIG. 2b is a schematic diagram of an information determination page of a combined hosted application according to the method for generating a hosted application of the present application;

FIG. 3a is a flowchart of another embodiment of a method for generating a hosted application according to the present application;

FIG. 3b is a schematic diagram of a page displayed by the combined hosted application according to the method for generating a hosted application of the present application;

FIG. 3c is a schematic diagram of another page displayed by the combined hosted application according to the method for generating a hosted application of the present application;

FIG. 3d is a schematic diagram of a further page displayed by the combined hosted application according to the method for generating a hosted application of the present application;

FIG. 3e is a schematic diagram of yet another page displayed by the combined hosted application according to the method for generating a hosted application of the present application;

FIG. 4 is a schematic structural diagram of an embodiment of an apparatus for generating a hosted application according to the present application; and

FIG. 5 is a schematic structural diagram of a computer system suitable for implementing an electronic device of the embodiments of the present application.

### DETAILED EMBODIMENTS

The following describes the present application in detail with reference to the accompanying drawings and embodiments. It can be understood that the specific embodiments described herein are only used to explain the related disclosure, but not to limit the disclosure. It should also be noted that, for convenience of description, only the parts related to the related disclosure are shown in the drawings.

It should be noted that, in the case of no conflict, the embodiments in the present application and the features in the embodiments can be combined with each other. The application will be described in detail below with reference to the drawings and embodiments.

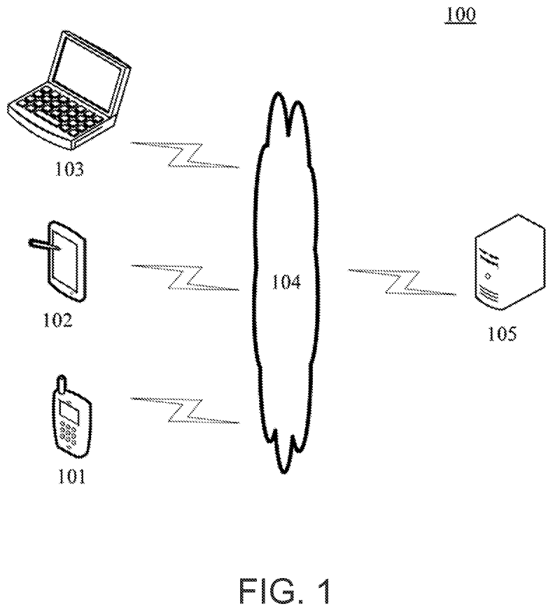

FIG. 1 shows an exemplary system architecture 100 to which an embodiment of a method for generating a hosted application or an apparatus for generating a hosted application of the present application may be applied.

As shown in FIG. 1, the system architecture 100 may include terminal devices 101, 102, and 103, a network 104, and a server 105. The network 104 is a medium for providing a communication link between the terminal devices 101, 102, 103 and the server 105. The network 104 may include various connection types, such as wired, wireless communication links, or fiber optic cables, among others.

The user can use the terminal devices 101, 102, 103 to interact with the server 105 through the network 104 to receive or send messages and the like. Various applications of communication client may be installed on the terminal devices 101, 102, 103, for example applications for generating hosted applications, video type host applications, live streaming type applications, instant messaging tools, email clients, social platform software, etc.

The terminal devices 101, 102, and 103 herein may be hardware, or may be software, In case of hardware, the terminals 101, 102, and 103 may be various electronic devices that have a display, including but not limited to; smart phones, tablets, e-book readers, laptop portable computers and desktop computers, etc. In case of software, the terminals 101, 102, and 103 may be installed in the electronic devices listed above. The terminal devices 101, 102, and 103 may be implemented as software or software modules (for example, software or software modules for providing distributed services), or as a single software or software module. No specific limitation is made herein.

The server 105 may be a server that provides various services, such as a background server that provides support for the terminal devices 101, 102, and 103. The background server may process (e.g., analyze) received data such as information on a combined hosted application, and feedback the processing result (e.g., a message pushed to the combined hosted application) to the terminal devices.

It should be understood that the numbers of terminal devices, networks, and servers in FIG. 1 are merely exemplary. Depending on the implementation needs, there can be any number of terminal devices, networks, and servers.

Hosted applications described herein are applications which operate with dependence on a host application. For example, the hosted applications may be applets, mini applications, quick applications, etc.

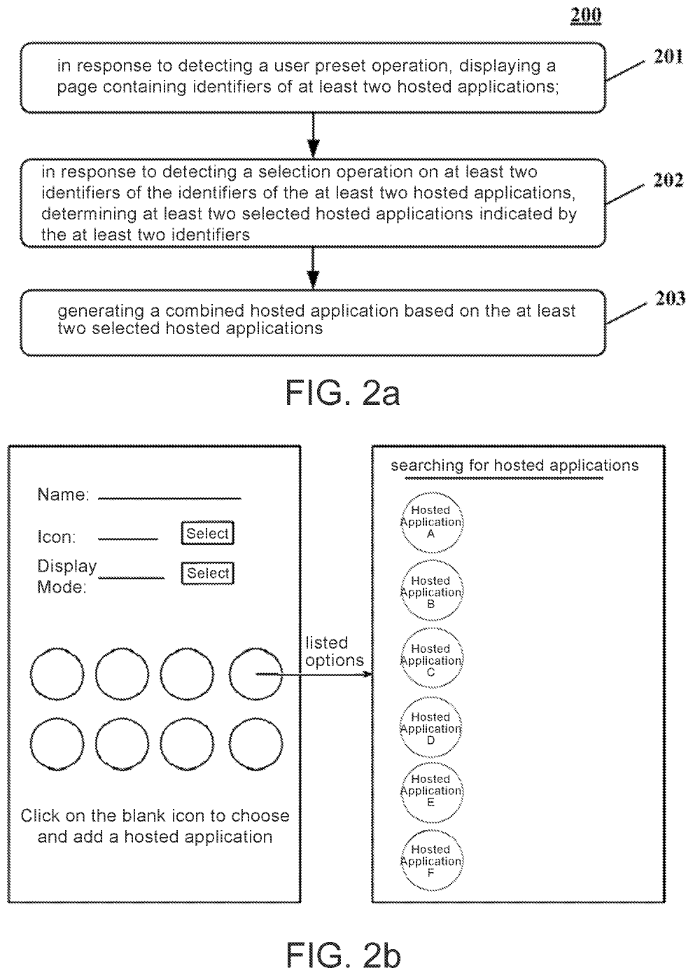

Continued reference is made to FIG. 2, which shows a flow 200 of an embodiment of a method for generating a hosted application according to the present application. The method for generating a hosted application is implemented at a terminal device. The terminal device is installed with a host application in which there are at least two hosted applications which operate with dependence on the host application. The above method comprises the following steps.

At step 201, a page containing identifiers of the at least two hosted applications is displayed in response to detecting a user preset operation.

In this embodiment, an entity for performing the method for generating a hosted application (e.g., the terminal device as shown in FIG. 1) may display a page containing identifiers of the above at least two hosted applications on a display of the terminal device in response to detecting a user preset operation. Specifically, the above at least two hosted applications may be hosted applications integrated in a same application or hosted applications integrated in different applications. The user preset operation is an operation performed by a user to instruct the terminal device to display the above page containing the identifiers of the hosted applications. The page may be preset. The user may edit on the page to integrate more than two hosted applications into one module which corresponds to a new hosted application to be generated. The identifiers of the hosted applications herein may be icons and/or names, etc., of the hosted applications.

At step 202, at least two selected hosted applications indicated by at least two identifiers of the identifiers of the at least two hosted applications are determined in response to detecting a selection operation on the at least two identifiers.

In this embodiment, the above entity may determine, in response to detecting a selection operation on at least two identifiers of the identifiers of the at least two hosted applications, at least two hosted applications indicated by the above at least two identifiers which receive the selection operation, and determine the at least two hosted applications as selected hosted applications. Specifically, each of the above at least two identifiers may receive the selection operation in any order. If a selection operation in an area of the page in which an identifier is located is received from the user, the above entity may determine that the user has performed the selection operation on the identifier, i.e., the user has selected the identifier. The area in which the identifier is located is an area containing the identifier in the page, such as a rectangular area or a circular area containing the identifier, etc.

At step 203, a combined hosted application is generated based on the at least two selected hosted applications, wherein the combined hosted application is used to display a page of any one or more of the at least two selected hosted applications.

In this embodiment, the above entity may generate a combined hosted application based on the above at least two selected hosted applications. Specifically, the hosted application is a Hyper Text Markup Language (HTML) page, and thus to generate the combined hosted application is to determine page content of the HTML page to be displayed. The page content of one of the above at least two selected hosted applications may be displayed in full screen in the page of the combined hosted application, or the page contents of multiple ones of the above at least two selected hosted applications may be displayed at the same time in the page of the combined hosted application. In addition, the combined hosted application may also be used to display an identifier of at least one of the above selected hosted applications. At least one of the selected hosted applications refers to any one of the above at least two selected hosted applications or a combination of any ones of the selected hosted applications.

In some implementations of this embodiment, the identifier comprises an icon. The method further comprises:

acquiring an icon generation mode for the combined hosted application; in response to the icon generation mode being configured as an all-icon mode, generating a thumbnail for icons of the at least two selected hosted applications, and determining the thumbnail as the icon of the combined hosted application; and in response to the icon generation mode being configured as a custom mode, receiving an icon selection operation, determining at least two icons indicated by the icon selection operation from the icons of the at least two selected hosted applications, generating a thumbnail for the at least two icons, and determining the thumbnail for the at least two icons as the icon of the combined hosted application.

In these implementations, the above entity may acquire the icon generation mode. If the icon generation mode is configured as an all-icon mode, an icon thumbnail is generated directly from the icons of all hosted applications of the above at least two selected hosted applications, and is determined as the icon of the combined hosted application. If the icon generation mode is configured as a custom mode, the above entity may determine at least two icons selected by the user via the user's icon selection operation and generate a thumbnail for the at least two icons. After that, the above entity may identify the thumbnail for the above at least two icons as the icon of the combined hosted application. The icon generation mode for the combined hosted application refers to the mode used to generate the icon of the combined hosted application. The thumbnail for the at least two icons may contain the above at least two icons. The size of each of the icons in the thumbnail may be smaller than its original one. The all-icon mode herein is used to indicate that the icon of the combined hosted application is generated with all icons of the selected hosted applications.

Specifically, the above entity may acquire the icon generation mode in various ways. For example, the above entity may acquire an icon generation mode which is pre-stored locally. In addition, the icon generation mode may also be selected by the user.

In these implementations, a thumbnail may be generated in various ways and the generated thumbnail of the combined hosted application is enabled to represent the combined hosted application accurately. In addition, in some cases, the user may be involved in the process of generating the icon with customization from the user, which enables the generated identifier to reflect more of the user's will and provides richer generation results.

In some implementations of this embodiment, the identifier comprises an icon. The method further comprises: displaying information indicating that an icon is to be determined, receiving an input image, wherein the input image is an image selected by the user on the terminal device; and determining the image as the icon of the combined hosted application.

In these implementations, the above entity may receive an image inputted by the user and determine the image as the icon of the combined hosted application. The information indicating that an icon is to be determined is used to indicate that the icon of the combined hosted application is to be determined, which is the information used to prompt the user to determine the icon. For example, the information indicating that an icon is to be determined may be characters and/or patterns, etc.

In these implementations, any image selected by the user may be determined as the icon of the combined hosted application to enable the icon to be more personalized and richer.

In some implementations of this embodiment, information indicating that a name is to be determined is displayed, and characters indicated by a name input operation is determined in response to detecting the name input operation. The characters are determined as the name of the combined hosted application.

In these implementations, the above entity may determine the characters inputted by the user as the name of the combined hosted application in response to detecting the name input operation from the user. The name input operation is an operation of inputting the name of the combined hosted application by the user. Specifically, information indicating that a name is to be determined is used to indicate that the name of the combined hosted application is to be determined, which is the information used to prompt the user to determine the name. For example, the information indicating that a name is to be determined may be characters and/or patterns, etc. As shown in FIG. 2b, information indicating that a name is to be determined in FIG. 2b is “Name: ______”. The user can enter a name in the blank of the “______”. Also, the user may select hosted applications in FIG. 2b to generate a combined hosted application.

In these implementations, the name inputted by the user may be acquired to determine a personalized name for the combined hosted application which is desired by the user.

The method provided in the above embodiments of present application enables operations on multiple selected hosted applications in the combined hosted application, which prevents the user from switching between the multiple hosted applications in the foreground to operate on the multiple hosted applications, and provides convenience and efficiency to user operations.

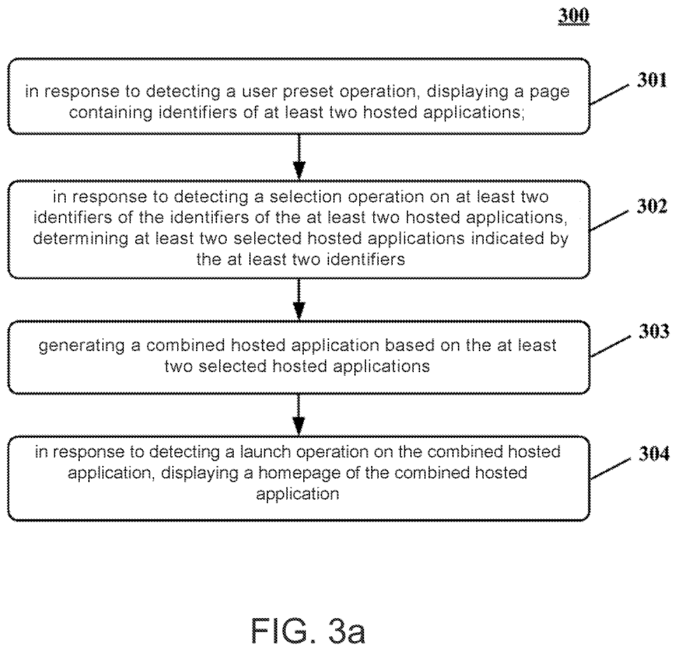

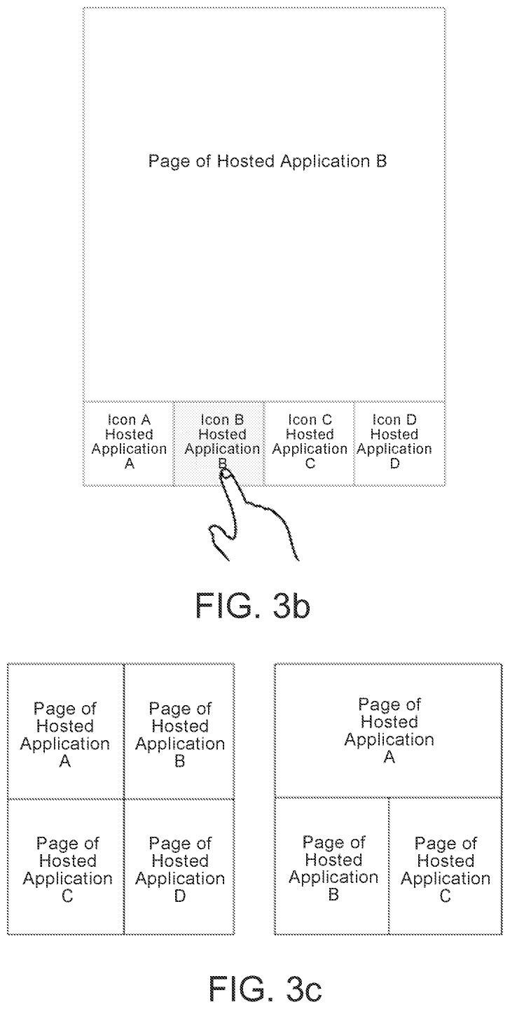

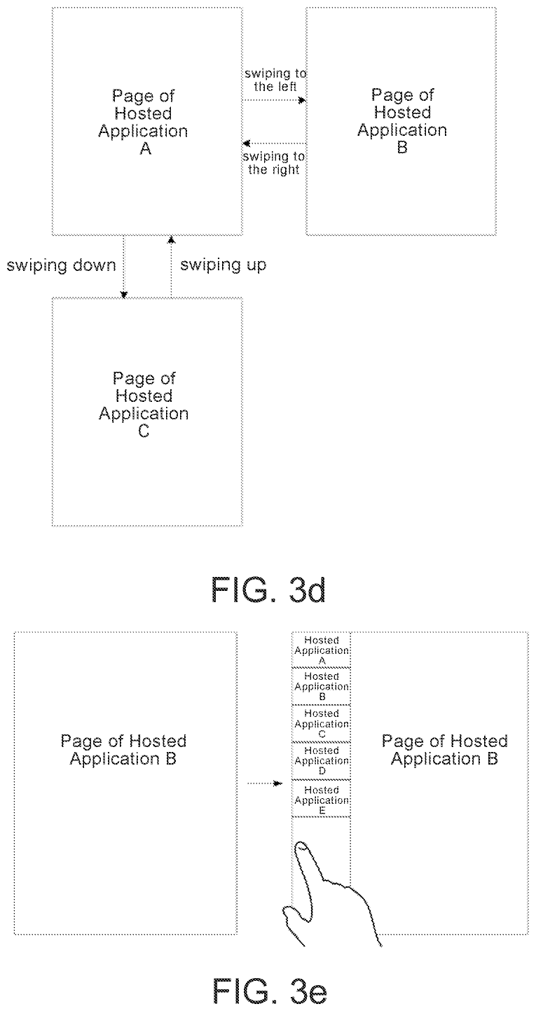

Further reference is made to FIG. 3, which shows a flow 300 of another embodiment of a method for generating a hosted application. The flow 300 of the method for generating a hosted application comprises the following steps.

At step 301, a page containing identifiers of at least two hosted applications is displayed in response to detecting a user preset operation.

In this embodiment, an entity for performing the method for generating a hosted application (e.g., the terminal device as shown in FIG. 1) may display, in response to detecting a user preset operation, a page containing identifiers of the at least two hosted applications as described above on a display of the terminal device. Specifically, the above at least two hosted applications may be hosted applications integrated in a same application or hosted applications integrated in different applications. The user preset operation is an operation performed by a user to instruct the terminal device to display the above page containing the identifiers of the hosted applications. The page may be preset. The user may edit on the page to integrate more than two hosted applications into one module which is a new hosted application to be generated. The identifiers of the hosted applications herein may be icons and/or names, etc., of the hosted applications.

At step 302, at least two selected hosted applications indicated by at least two identifiers of the identifiers of the at least two hosted applications are determined in response to detecting a selection operation on the at least two identifiers.

In this embodiment, the above entity may determine, in response to detecting a selection operation on at least two identifiers of the identifiers of the at least two hosted applications, at least two hosted applications indicated by the above at least two identifiers which receive the selection operation, and determine the at least two hosted applications as selected hosted applications. Specifically, each of the above at least two identifiers may receive the selection operation in any order.

At step 303, a combined hosted application is generated based on the at least two selected hosted applications, wherein the combined hosted application is used to display a page of at least any one of the at least two selected hosted applications.

In this embodiment, the above entity may generate a combined hosted application based on the above at least two selected hosted applications. Specifically, the hosted application is an HTML page (i.e., a Hyper Text Markup Language page), and thus to generate the combined hosted application is to determine the HTML page content to be displayed. The page content of one of the above at least two selected hosted applications may be displayed in full screen in the page of the combined hosted application, or the page contents of multiple ones of the above at least two selected hosted applications may be displayed at the same time in the page of the combined hosted application. In addition, the combined hosted application may also be used to display an identifier of at least one of the above selected hosted applications.

At step 304, a homepage of the combined hosted application is displayed in response to detecting a launch operation on the combined hosted application, wherein the homepage is used to display a page of at least one selected hosted application.

In this embodiment, the above entity may display the homepage of the combined hosted application in response to detecting a launch operation on the combined hosted application from the user. The homepage is a page which is displayed by default after the hosted application is launched. The launch operation is an operation performed by the user to instruct the combined hosted application to be launched. The homepage may display a page of the above at least any one of the selected hosted applications. Generally, pages of different hosted applications are different. In addition, the homepage may also display identifiers and/or names, etc., of the selected hosted applications. When the combined hosted application is launched, a preset page of the selected hosted applications may be displayed on the homepage.

In some implementations of this embodiment, the homepage is a tab page. The step 304 may comprise: displaying the identifiers of the at least two selected hosted applications in an identifier display area of the tab page and displaying a launch page in a page display area of the tab page, wherein the identifier display area comprises at least two subareas for displaying identifiers of the selected hosted applications, and the number of the subareas is identical with the number of the selected hosted applications, and wherein the launch page is a page of the selected hosted application.

In these implementations, the homepage may be a tab page. For example, the tab page may be a page with Tab. The tab page (also referred as a page labeled with tabs) is a form of interactive interface application. The tab page generally comprises a tab area and a data area. In this embodiment, the identifier display area is the tab area, and the page display area is the data area. In the tab page of this embodiment, the page content is displayed in the page display area.

The launch page that is displayed herein is a page displayed at first after the combined hosted application is launched. This page may be a page of any one of the above at least two selected hosted applications. The launch page may be preset.

In practice, each of the subareas may contain an identifier of the selected hosted application. The above entity may display a page of the selected hosted application indicated by the identifier contained in a subarea which is selected by the user via a subarea selection operation. As shown in FIG. 3b, if the user clicks on an identifier of the hosted application with a name of hosted application B (i.e., icon B), then the tab page may display the page of hosted application B.

In these implementations, the page displayed in the homepage may be flexibly switched between the pages of the various hosted applications by the user selecting the identifier of a hosted application. The operation of switching pages may be implemented in a more convenient and faster way.

In some application scenarios of these implementations, the method further comprises: in response to detecting a subarea selection operation on one of the subareas, highlighting the selected subarea or highlighting an identifier in the selected subarea, and displaying a page of the selected hosted application indicated by the identifier in the selected subarea in the page display area; and in response to detecting a display area operation on the page display area, executing instructions corresponding to the display area operation on the page displayed in the page display area.

In these application scenarios, when a subarea in which an identifier is located is selected by the user, the identifier or the subarea may be highlighted to indicate that the subarea is selected. Also, a page of the selected hosted application indicated by the identifier may be displayed in the page display area. The page displayed in the page display area may be a preset page which is displayed when the combined hosted application is launched, or may be another page which is reached by at least one jump from the preset page. If the user performs a display area operation on the page display area, the above entity may execute instructions corresponding to the operation on the page display area. For example, the instructions may indicate selection or page jump, etc. The display area operation is an operation performed by the user on the page display area. As an example, the display area operation may be to click in the page display area to enable page jump or selection on an option, etc. As another example, the display area operation may also be to swipe in the page display area to view a portion of the page beyond the portion that is currently displayed.

The highlighting herein may comprise setting a color and/or pattern different from other identifiers or subareas, adding underlines, bolding fonts, etc.

In these application scenarios, operations on a page of each of the selected hosted applications in the homepage of the combined hosted application may be enabled, which provides convenience and efficiency to the operation process.

In some implementations of this embodiment, the step 304 may comprise: displaying a page of each of the at least two selected hosted applications in split screens in the homepage; and in response to detecting a page operation on a page of one of the selected hosted applications displayed in split screens, executing instructions corresponding to the page operation on the page of one of the selected hosted applications displayed above in split screens.

In these implementations, the above entity may display the page of each of the selected hosted applications in split screens in the homepage of the combined hosted application. In this way, the page of each of the hosted applications occupies a portion of the homepage. In this way, the user may perform a page operation on the certain portion of the homepage occupied by each of the hosted applications displayed in split screens, and in turn the above entity may execute instructions corresponding to the page operation to enable the hosted application to operate in the combined hosted application. As shown in FIG. 3c, each of the selected hosted applications may be displayed in split screens in two ways shown in FIG. 3c.

In these implementations, simultaneous display of each of the selected hosted applications in split screens in the combined hosted application in the foreground may be enabled. The user may view the page content of each of the various hosted applications against each other, to compare the page contents of the various hosted applications.

In some implementations of this embodiment, the step 304 may comprise: displaying a page of one of the at least two selected hosted applications in full screen in the homepage of the combined hosted application; and in response to detecting a page switching operation, switching the page displayed in full screen from the page of the one of the selected hosted applications which is being displayed in full screen to a page of another one of the at least two selected hosted applications.

In these implementations, the above entity may display the page content of one of the above selected hosted applications in full screen in the homepage of the combined hosted application. Also, the user may switch the currently displayed page to a page of another selected hosted application by the page switching operation. The one of the selected hosted applications herein may be preset. For example, the one of the selected hosted applications that is preset may be the first one of the selected hosted applications added to the combined hosted application when the user edits, or the latest one of the selected hosted applications used by the user. As shown in FIG. 3d, the user may switch pages through swiping.

In these implementations, a page of a hosted application may be clearly displayed in full screen in the combined hosted application, and the user may flexibly view information on any hosted application in the combined hosted application through page switching.

In some application scenarios of these implementations, the page switching operation comprises a first switching operation and a second switching operation. The above step of switching, in response to detecting a page switching operation, the page displayed in full screen from the page of the one of the selected hosted applications which is being displayed in full screen to a page of another one of the at least two selected hosted applications comprises:

switching, in response to detecting the first switching operation, the page displayed in full screen from the page of the one of the selected hosted applications which is being displayed in full screen to a page of a first hosted application of the at least two selected hosted applications; and switching, in response to detecting the second switching operation, the page displayed in full screen from the page of the one of the selected hosted applications which is being displayed in full screen to a page of a second hosted application of the at least two selected hosted applications.

In these application scenarios, the above entity may switch the currently displayed page to a page of a different selected hosted application upon receiving different page switching operations. For example, the page switching operation may comprise swiping such as to the left, to the right, up and/or down, or clicking on a page edge, such as on the left, right, top and/or bottom edge of a page. The first switching operation and the second switching operation may be different operations as described above respectively. For example, the first switching operation may be swiping to the left or swiping to the right which allows the page to be switched to a page of hosted application A. The second switching operation may be swiping up or swiping down, which allows the page to be switched to a page of hosted application B.

In these application scenarios, accurate switch to a page of a target hosted application with different page switching operations may be enabled, which expedites the switching process.

In some implementations of this embodiment, the step 304 may comprise: displaying a page of one of the at least two selected hosted applications in full screen in the homepage of the combined hosted application; in response to detecting a user-triggered operation on a page edge of the page displayed in full screen, displaying the identifiers of the at least two selected hosted applications at the page edge; and in response to detecting a area selection operation in an identifier area where one of the identifiers of the at least two selected hosted applications displayed at the page edge is located, displaying a page of the selected hosted application indicated by the one of the identifiers.

In these implementations, the above entity may display the page content of one of the selected hosted applications in full screen in the homepage of the combined hosted application and display a navigation bar in response to a user-triggered operation on a page edge of the page. Multiple identifier areas may be comprised in the navigation bar. Each of the identifier areas displays an identifier of one of the selected hosted applications. When the user performs an area selection operation on one of the identifier areas, the above entity may display the page of the selected hosted application indicated by the operation in the combined hosted application. For example, when the user clicks on the left edge of the page, identifiers of the various selected hosted applications may be displayed on the left edge for the user to select. As shown in FIG. 3e, when the user clicks on or swipes the left edge of the page, the identifier areas of the various selected hosted applications may appear.

In these implementations, the configuration of hidden identifier areas may facilitate clear view of a page of a hosted application displayed in full screen by the user as well as quick view of the page content of another selected hosted application in the combined hosted application through some simple operations by the user.

In some application scenarios of these implementations, the above step of displaying the page of one of the at least two selected hosted applications in full screen in the homepage of the combined hosted application comprises:

in response to determining that the number of the selected hosted applications of the at least two selected hosted applications is above a preset number threshold, displaying the page of one of the at least two selected hosted applications in full screen in the combined hosted application.

In these application scenarios, the above entity may display the page with the above configuration of hidden identifier areas if the number of the selected hosted applications involved in the combination is greater than the preset number threshold. In this way, even if the number of the selected hosted applications involved in the combination is very large, the process of viewing the page by the user would not affected due to the hidden identifier areas.

In some implementations of this embodiment, the method further comprises:

in response to detecting a page selection operation on a target page of the selected hosted application, determining the target page as a launch page of the combined hosted application.

In these implementations, the launch page of the combined hosted application may be determined through a user's selection. In this way, the page which is first displayed in the combined hosted application for the selected hosted application after the combined hosted application is launched may be configured freely by the user. The launch page is the page which is first displayed in the homepage of the combined hosted application after the combined hosted application is launched. The selected hosted application to which the target page herein belongs is any one of the above at least two selected hosted applications.

In these implementations, the user is allowed to select the launch page. In this way, the user is able to select and adjust the launch page as needed.

In some implementations of this embodiment, the step 303 may comprise: generating a profile for the combined hosted application, wherein the profile comprises a path to configuration information on the page of each of the at least two selected hosted applications and name and/or identifier of each of the at least two selected hosted applications; and after displaying the homepage of the combined hosted application, the method further comprises: in response to detecting a display operation on the homepage which indicative of displaying a page of any one of the at least two selected hosted applications, reading configuration information on the page of the selected hosted application according to the path to the configuration information on the page of the selected hosted application in the profile, and displaying the page of the selected hosted application and displaying the name and/or identifier of the selected hosted application.

In these implementations, the above entity may generate a profile for the combined hosted application and store a path to configuration information on the page of each of the selected hosted applications in the profile. In this way, the above entity may read the configuration information to display the page of each of the selected hosted applications in the combined hosted application. Configuration information on a page refers to various types of information on the construction of the page such as information on page color and information on page text, etc.

In these implementations, the display of pages of the selected hosted applications in the combined hosted application may be guaranteed through the paths to configuration information on the pages.

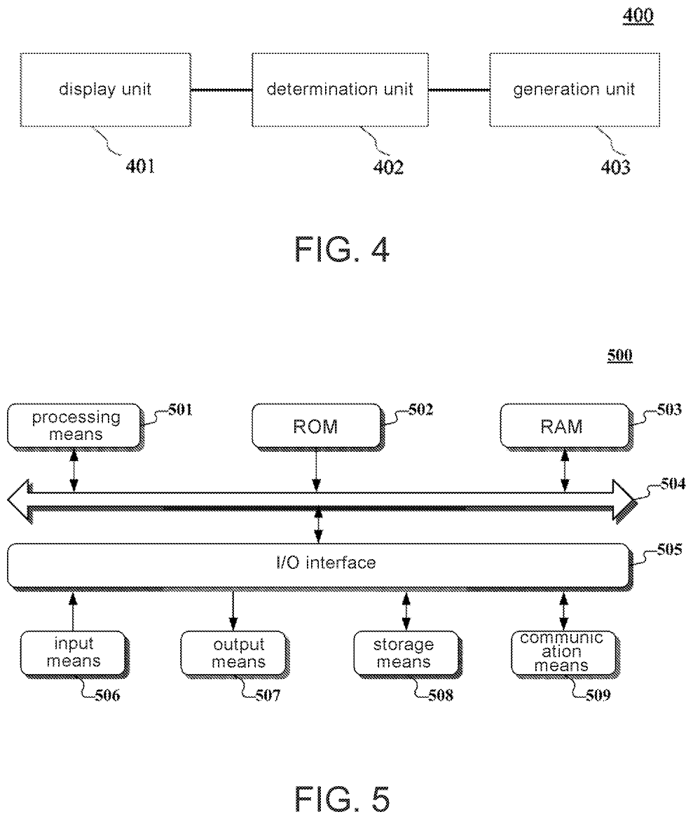

With further reference to FIG. 4, as an implementation of the methods shown in the foregoing figures, the present application provides an embodiment of an apparatus for generating a hosted application. This apparatus embodiment corresponds to the method embodiment shown in FIG. 2, and the apparatus can be specifically implemented at various electronic devices.

As shown in FIG. 4, the apparatus 400 for generating a hosted application of this embodiment comprises: a display unit 401, a determination unit 402 and a generation unit 403. The display unit 401 is configured to display, in response to detecting a user preset operation, a page containing identifiers of at least two hosted applications. The determination unit 402 is configured to determine, in response to detecting a selection operation on at least two identifiers of the identifiers of the at least two hosted applications, at least two selected hosted applications indicated by the at least two identifiers. The generation unit 403 is configured to generate a combined hosted application based on the at least two selected hosted applications, wherein the combined hosted application is used to display a page of at least any one of the at least two selected hosted applications.

In some embodiments, the display unit 401 of the apparatus 400 for generating a hosted application may display, in response to detecting a user preset operation, a page containing identifications of the above at least two hosted applications on a display of the terminal device. Specifically, the above at least two hosted applications may be hosted applications hosted in a same application or hosted applications hosted in different applications. The user preset operation is an operation performed by a user to instruct the terminal device to display the above page containing the identifiers of the hosted applications. The page may be preset.

In some embodiments, the determination unit 402 may determine, in response to detecting a selection operation on at least two identifiers of the identifiers of the at least two hosted applications, at least two hosted applications indicated by the above at least two identifiers that receive the selection operation, and determine the at least two hosted applications as selected hosted applications.

In some embodiments, the generation unit 403 may generate a combined hosted application based on the above at least two selected hosted applications. Specifically, the hosted application is an HTML page (i.e., a Hyper Text Markup Language page), and thus to generate the combined hosted application is to determine the page content of the HTML page to be displayed. The page content of one of the above at least two selected hosted applications may be displayed in full screen in the page of the combined hosted application, or the page contents of multiple ones of the above at least two selected hosted applications may be displayed at the same time in the page of the combined hosted application.

In some implementations of this embodiment, the apparatus further comprises: a homepage display unit configured to display, in response to detecting a launch operation on the combined hosted application, a homepage of the combined hosted application, wherein the homepage comprises a page for displaying at least one selected hosted application.

In some implementations of this embodiment, the homepage is a tab page. The homepage display unit is further configured to: display the identifiers of the at least two selected hosted applications in an identifier display area of the tab page and display a launch page in a page display area of the tab page, wherein the identifier display area comprises at least two subareas for displaying identifiers of the selected hosted applications, and the number of the subareas is identical with the number of the selected hosted applications, and wherein the launch page is a page of the selected hosted application.

In some implementations of this embodiment, the apparatus further comprises: a highlighting unit configured to highlight, in response to detecting a selection operation on one of the subareas, the selected subarea or highlight an identifier in the selected subarea, and display a page of the selected hosted application indicated by the identifier in the selected subarea in the page display area; and an execution unit configured to execute, in response to detecting a display area operation on the page display area, instructions corresponding to the display area operation on a page displayed in the page display area.

In some implementations of this embodiment, the homepage display unit is further configured to: display a page of each of the at least two selected hosted applications in split screens in the homepage; and execute, in response to detecting a page operation on a page of one of the selected hosted applications displayed in split screens, instructions corresponding to the page operation on the above page of the one of the selected hosted applications displayed in split screens.

In some implementations of this embodiment, the homepage display unit is further configured to: display a page of one of the at least two selected hosted applications in full screen in the homepage of the combined hosted application; and switch, in response to detecting a page switching operation, the page displayed in full screen from the page of the one of the selected hosted applications to a page of another one of the at least two selected hosted applications.

In some implementations of this embodiment, the homepage display unit is further configured to: display a page of one of the at least two selected hosted applications in full screen in the homepage of the combined hosted application; and display, in response to detecting a user-triggered operation on a page edge of the page displayed in full screen, the identifiers of the at least two selected hosted applications at the page edge; and display, in response to detecting an area selection operation in an identifier area where one of the identifiers of the at least two selected hosted applications displayed at the page edge is located, a page of the selected hosted application indicated by the one of the identifiers.

In some implementations of this embodiment, the homepage display unit is further configured to: display the page of the one of the at least two selected hosted applications in full screen in the combined hosted application if the number of the at least two selected hosted applications is above a preset number threshold.

In some implementations of this embodiment, the apparatus further comprises: a page determination unit configured to determine, in response to detecting a page selection operation on a target page of the selected hosted application, the target page as a launch page of the combined hosted application.

In some implementations of this embodiment, the homepage display unit is further configured to: generate a profile for the combined hosted application, wherein the profile comprises a path to configuration information on the page of each of the at least two selected hosted applications and name and/or identifier of each of the at least two selected hosted applications. The apparatus further comprises: a reading unit configured to read, in response to detecting a display operation on the homepage indicative of displaying a page of any one of the at least two selected hosted applications, configuration information on the page of the selected hosted application according to the path to the configuration information on the page of the selected hosted application in the profile, and display the page of the selected hosted application and display the name and/or identifier of the selected hosted application.

In some implementations of this embodiment, the identifier comprises an icon. The apparatus further comprises: an acquisition unit configured to acquire an icon generation mode for the combined hosted application; a thumbnail generation unit configured to generate a thumbnail for icons of the at least two selected hosted applications, and determine the thumbnail as the icon of the combined hosted application if the icon generation mode is configured as an all-icon mode; and a thumbnail determination unit configured to receive an icon selection operation, determine at least two icons indicated by the icon selection operation from the icons of the at least two selected hosted application, generate a thumbnail for the at least two icons, and determine the thumbnail for the at least two icons as the icon of the combined hosted application, if the icon generation mode is configured as a custom mode.

In some implementations of this embodiment, the identifier comprises an icon. The apparatus further comprises: a first information display unit configured to display information indicating that an icon is to be determined, receive an input image, wherein the input image is an image selected by a user on the terminal device; and an icon determination unit configured to determine the image as the icon of the combined hosted application.

In some implementations of this embodiment, the apparatus further comprises: a second information display unit configured to display information indicating that a name is to be determined, and determine characters indicated by a name input operation in response to detecting the name input operation; and a name determination unit configured to determine the characters as the name of the combined hosted application.

As shown in FIG. 5, an electronic device 500 may include a processing means (such as a central processing unit, a graphic processing unit) 501, which can perform various appropriate actions and processing according to the programs stored in a read-only memory (ROM) 502 or programs loaded from a storage means 508 into a random access memory (RAM) 503. In the RAM 503, various programs and data necessary for the operations of the electronic device 500 are also stored. The processing means 501, ROM 502, and RAM 503 are connected to each other via a bus 504. An input/output (I/O) interface 505 is also connected to the bus 504.

Generally, the following means may be connected to the I/O interface 505: an input means 506 including for example a touch screen, a touch panel, a keyboard, a mouse, a camera, a microphone, an accelerometer and a gyroscope etc.; an output means 507 including for example a Liquid Crystal Display (LCD), a speaker and a vibrator etc.; the storage means 508; and a communication means 509. The communication means 509 may permit the electronic device 500 to conduct wireless or wired communication with other devices to exchange data. While FIG. 5 shows an electronic device 500 with various means, it should be understood that it is not required to implement or possess all the means shown. More or fewer means may be implemented or provided instead. Each block shown in FIG. 5 may represent one means, or may represent multiple means as needed.

In particular, according to the embodiments of the present disclosure, the processes described above with reference to the flowcharts may be implemented as computer software programs. For example, embodiments of the present disclosure include a computer program product including a computer program carried on a computer readable medium, the computer program containing program code for performing a method shown in a flowchart. In such embodiments, the computer program may be download and installed from a network though the communication means 509, or installed from the storage means 508, or installed from the ROM 502. The computer program, when executed by the processing means 501, executes the above functions defined in the method of the embodiments of the present disclosure. It should be noted that the computer readable medium in the embodiments of the present disclosure may be a computer readable signal medium or a computer readable storage medium or any combination of the above two. The computer readable storage medium may be, for example, but not limited to, an electronic, magnetic, optical, electromagnetic, infrared, or semiconductor system, apparatus, or device, or any combination thereof. More specific examples of the computer readable storage medium may include, but are not limited to: electrical connections with one or more wires, portable computer magnetic disks, hard disks, random access memory (RAM), read-only memory (ROM), erasable Programming read-only memory (EPROM or flash memory), optical fiber, portable compact disk read-only memory (CD-ROM), optical storage device, magnetic storage device, or any suitable combination of the foregoing. In the embodiments of the present disclosure, a computer readable storage medium may be any tangible medium that contains or stores a program that can be used by or in combination with an instruction execution system, apparatus, or device. In the embodiments of the present disclosure, a computer readable signal medium may include a data signal that is included in a baseband or propagated as part of a carrier wave, and which carries computer readable program code. Such a propagated data signal may take many forms, including but not limited to electromagnetic signals, optical signals, or any suitable combination of the foregoing. A computer readable signal medium may also be any computer readable medium other than a computer readable storage medium, and the computer readable signal medium may send, propagate, or transmit a program for use by or in connection with an instruction execution system, apparatus, or device. Program code embodied on a computer readable medium may be transmitted using any appropriate medium, including but not limited to: wired, optical fiber cable, radio frequency (RF) etc., or any suitable combination of the foregoing.

The flowchart and block diagrams in the accompanying drawings illustrate the architecture, functionality, and operation of possible implementations of systems, methods and computer program products according to various embodiments of the present application. In this regard, each block in the flowchart or block diagram may represent a module, a program segment, or a part of code, a portion of which contains one or more executable instructions for implementing a specified logical function. It should also be noted that in some alternative implementations, the functions labeled in the blocks may also occur in a different order than those labeled in the drawings. For example, two successively represented blocks may actually be executed substantially in parallel, and they may sometimes be executed in a reverse order, depending on the functions involved. It should also be noted that each block in the block diagrams and/or flowcharts, and combinations of blocks in the block diagrams and/or flowcharts, can be implemented by a dedicated hardware-based system that performs the specified function or operation, or it can be implemented with a combination of dedicated hardware and computer instructions.

The units described in the embodiments of the present application may be implemented by software or hardware. The described unit may also be provided in a processor. For example, it may be described as: a processor comprising a display unit, a determination unit and a generation unit. The name of the unit does not constitute a limitation on the unit per se in some cases. For example, the generation unit may also be described as “a unit for generating a combined hosted application based on at least two selected hosted applications”.

As another aspect, the present application further provides a computer readable medium, which may be included in the apparatus described in the foregoing embodiments; or may exist alone without being assembled into the apparatus. The computer readable medium carries one or more programs. When the one or more programs are executed by the apparatus, the apparatus is caused to: display, in response to detecting a user preset operation, a page containing identifiers of at least two hosted applications; determine, in response to detecting a selection operation on at least two identifiers of the identifiers of the at least two hosted applications, at least two selected hosted applications indicated by the at least two identifiers; and generate a combined hosted application based on the at least two selected hosted applications, wherein the combined hosted application is used to display a page of at least any one of the at least two selected hosted applications.

The above description is only a preferred embodiment of the present application and an explanation of the technical principles applied. Those skilled in the art should understand that the protection scope involved in the present application is not limited to the technical solution composed of a specific combination of the above-mentioned technical features, but should also cover other technical solutions formed by any arbitrary combination of the above-mentioned technical features or their equivalents without departing from the above inventive concept. For example, a technical solution formed by replacing the technical features disclosed (but not limited to) in the present application with technical features having similar functions.

What is claimed is:

1. A method, implemented at a terminal device, for generating a hosted application, the terminal device being installed with a host application in which there are at least two hosted applications which operate with dependence on the host application, the method comprising:
in response to detecting a user preset operation, displaying a page containing identifiers of the at least two hosted applications;
in response to detecting a selection operation on at least two identifiers of the identifiers of the at least two hosted applications, determining at least two selected hosted applications indicated by the at least two identifiers; and
generating a combined hosted application based on the at least two selected hosted applications, wherein the combined hosted application comprises a page for displaying any one or more of the at least two selected hosted applications.

2. The method as recited in claim 1, wherein the method further comprising:
in response to detecting a launch operation on the combined hosted application, displaying a homepage of the combined hosted application, wherein the homepage comprises a page for displaying at least one selected hosted application.

3. The method as recited in claim 2, wherein the homepage is a tab page;
the displaying the homepage of the combined hosted application comprising:
displaying the identifiers of the at least two selected hosted applications in an identifier display area of the tab page and displaying a launch page in a page display area of the tab page, wherein the identifier display area comprises at least two subareas for displaying the identifiers of the selected hosted applications, and the number of the subareas is identical with the number of selected hosted applications, and wherein the launch page is a page of the selected hosted application.

4. The method as recited in claim 3. wherein the method further comprising:
in response to detecting a selection operation on one of the subareas, highlighting the selected subarea or highlighting the identifier in the selected subarea, and displaying a page of the selected hosted application indicated by the identifier in the selected subarea in the page display area; and
in response to detecting a display area operation on the page display area, executing instructions corresponding to the display area operation on the page displayed in the page display area.

5. The method as recited in claim 2, wherein the displaying the homepage of the combined hosted application comprising:
displaying a page of each of the at least two selected hosted applications in split screens in the homepage of the combined hosted application; and
in response to detecting a page operation on a page of one of the selected hosted applications displayed in split screens, executing instructions corresponding to the page operation on the page of the one of the selected hosted applications displayed in split screens.

6. The method as recited in claim 2, wherein the displaying the homepage of the combined hosted application comprising:
displaying a page of one of the at least two selected hosted applications in full screen in the homepage of the combined hosted application; and
in response to detecting a page switching operation, switching the page displayed in full screen from the page of the one of the selected hosted applications to a page of another one of the at least two selected hosted applications.

7. The method as recited in claim 2, wherein the displaying the homepage of the combined hosted application comprising:
displaying a page of one of the at least two selected hosted applications in full screen in the homepage of the combined hosted application;
in response to detecting a user-triggered operation on a page edge of the page displayed in full screen, displaying the identifiers of the at least two selected hosted applications at the page edge; and
in response to detecting an area selection operation in an identifier area where one of the identifiers of the at least two selected hosted applications displayed at the page edge is located, displaying a page of the selected hosted application indicated by the one of the identifiers.

8. The method as recited in claim 7, wherein the displaying the page of one of the at least two selected hosted applications in full screen in the homepage of the combined hosted application comprising:
displaying the page of one of the at least two selected hosted applications in full screen in the combined hosted application if the number of the at least two selected hosted applications is above a preset number threshold.

9. The method as recited in claim 1, wherein the method further comprising:
in response to detecting a page selection operation on a target page of the selected hosted application, determining the target page as the launch page of the combined hosted application.

10. The method as recited in claim 2, wherein the generating the combined hosted application comprising: generating a profile for the combined hosted application, wherein the profile comprises a path to configuration information on the page of each of the at least two selected hosted applications and name and/or identifier of each of the at least two selected hosted applications; and
after displaying the homepage of the combined hosted application, the method further comprising:
in response to detecting a display operation on the homepage indicative of displaying a page of any one of the at least two selected hosted applications, reading configuration information on the page of the selected hosted application according to the path to the configuration information on the page of the selected hosted application in the profile, and displaying the page of the selected hosted application and displaying the name and/or identifier of the selected hosted application.

11. The method as recited in claim 1, wherein the identifier comprises an icon, and the method further comprising:
acquiring an icon generation mode for the combined hosted application;
if the icon generation mode is configured as an all-icon mode, generating a thumbnail of icons of the at least two selected hosted applications, and determining the thumbnail as the icon of the combined hosted application; and
if the icon generation mode is configured as a custom mode, receiving an icon selection operation, determining at least two icons indicated by the icon selection operation from the icons of the at least two selected hosted applications, generating a thumbnail of the at least two icons, and determining the thumbnail of the at least two icons as the icon of the combined hosted application.

12. The method as recited in claim 1, wherein the identifier comprises an icon, and the method further comprising:
displaying information indicating that an icon is to be determined, receiving an input image, wherein the input image is an image selected by a user on the terminal device; and
determining the image as the icon of the combined hosted application.

13. The method as recited in claim 1, wherein the method further comprising:
displaying information indicating that a name is to be determined, determining characters indicated by the name input operation in response to detecting the name input operation; and
determining the characters as the name of the combined hosted application.

14. An electronic device, comprising:
one or more processors; and
storage means for storing one or more programs,
wherein the one or more programs, when executed by the one or more processors, cause the one or more processors:
in response to detecting a user preset operation, display a page containing identifiers of the at least two hosted applications;
in response to detecting a selection operation on at least two identifiers of the identifiers of the at least two hosted applications, determine at least two selected hosted applications indicated by the at least two identifiers; and
generate a combined hosted application based on the at least two selected hosted applications, wherein the combined hosted application comprises a page for displaying any one or more of the at least two selected hosted applications.

15. A computer readable storage medium storing computer programs thereon, the computer programs, when executed by a processor, cause the processor to:
in response to detecting a user preset operation, display a page containing identifiers of the at least two hosted applications;
in response to detecting a selection operation on at least two identifiers of the identifiers of the at least two hosted applications, determine at least two selected hosted applications indicated by the at least two identifiers; and
generate a combined hosted application based on the at least two selected hosted applications, wherein the combined hosted application comprises a page for displaying any one or more of the at least two selected hosted applications.
